(19) United States
(12) Patent Application Publication
(10) Pub. No.: US 2006/0262572 A1
(43) Pub. Date: Nov. 23, 2006

(54) Light guide plate and liquid crystal display device having the light guide plate

(75) Inventor: Hideaki Nagakubo, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/435,667

(22) Filed: May 17, 2006

(30) Foreign Application Priority Data
May 18, 2005 (JP) 2005-145218

(51) Int. Cl. F21V 7/04

(52) U.S. Cl. 362/634; 362/626; 362/629

(57) ABSTRACT

A liquid crystal display device is provided. The liquid crystal display device mainly includes a front light serving as a surface-emitting device and including a light guide plate and a light source, and a liquid crystal display panel mounted on one principal surface of the front light. The light guide plate includes retaining portions serving as holding portions that extend in the normal direction of the principal surface. The retaining portions respectively have retaining claws at their leading ends, and hold the liquid crystal display panel therein.

### BACKGROUND OF THE INVENTION

1. Field of the Invention

The present invention relates to a light guide plate, and to a liquid crystal display device having the light guide plate.

2. Description of the Related Art

Surface-emitting devices, such as front lights, for illuminating a liquid crystal display panel are known as illumination means for display devices, mainly liquid crystal display devices. The front lights mainly include a light source, and a light guide plate that emits light from the light source toward a liquid crystal display panel.

FIG. 5 shows the configuration of a known liquid crystal display device. The liquid crystal display device shown in FIG. 5 includes a liquid crystal display panel 4, a front light provided above the liquid crystal display panel 4 and including a light guide plate 1, and a cover 5 provided above the light guide plate 1. The light guide plate 1 is shaped like a flat plate, and includes a pair of opposing principal surfaces and a pair of opposing end faces. A plurality of prisms 1a are provided on one of the principal surfaces (a principal surface adjacent to a viewer). A light guide bar 3 is provided near one of the end faces, and a light source 2 is provided at one end of the light guide bar 3.

In the front light, light from the light source 2 enters the end face of the light guide plate 1, and propagates inside the light guide plate 1. The light is reflected by the prisms 1a in the light guide plate 1, is directed toward the liquid crystal display panel 4, as shown by the arrow in the figure, is reflected by the liquid crystal display panel 4, and travels toward the viewer through the light guide plate 1 and the cover 5.

Japanese Unexamined Patent Application Publication No. 11-109347 (U.S. Pat. No. 6,104,453) discloses a liquid crystal display device including a front light that has a structure similar to that of the above-described front light.

The front light and the liquid crystal display panel 4 shown in FIG. 5 are separately produced, and are combined into a module in a later process. For this reason, it is necessary to align the front light and the liquid crystal display panel 4 in the process. Further, when the front light and the liquid crystal display panel 4 are combined, glass of the liquid crystal display panel 4 is cracked, and foreign substances enter therebetween.

### SUMMARY OF THE INVENTION

The present invention has been made in view of these problems, and an object of the invention is to provide a light guide plate that does not need to be aligned with a liquid crystal display panel and that can protect the liquid crystal display panel, and a liquid crystal display device having the light guide plate.

A light guide plate according to an aspect of the present invention includes first and second principal surfaces that oppose each other; an end face through which light from a light source enters the light guide plate; and a holding portion extending in a normal direction of the first principal surface. The first principal surface has a plurality of prisms, and the second principal surface is flat.

In this case, the light guide plate can be easily aligned and combined with the liquid crystal display panel without performing any special operation. Further, since the load and impact are absorbed by the holding portion of the light guide plate, the liquid crystal display panel is protected.

Preferably, each of the prisms includes a first face that is inclined, a second face that is inclined more steeply than the first face and is farther from the end face than the first face, and a third face provided between the first face and the second face. An angle formed between the second face and the third face is acute.

In this case, the first principal surface having the prism faces the liquid crystal display panel, and the second principal surface is flat. For this reason, a cover for protecting the prisms of the light guide plate is unnecessary, and an optical element can be easily mounted on the flat second principal surface of the light guide plate, as necessary.

A liquid crystal display device according to another aspect of the present invention includes the above-described light guide plate, a light source provided near the end face of the light guide plate, and a liquid crystal display panel facing the first principal surface of the light guide plate and held by the holding portion.

In this case, since the light guide plate and the liquid crystal display panel are combined, the rigidity and strength of the liquid crystal display device increase as a whole. That is, the load applied to the liquid crystal display panel can be reduced, and therefore, the substrates of the liquid crystal display panel are prevented from cracking. Further, since the liquid crystal display panel is guided and held by the holding portion of the light guide plate, it is aligned and combined with the light guide plate 11 without performing any special operation. Moreover, since the liquid crystal display panel and the light guide plate are combined, foreign substances are prevented from entering therebetween, and a waterproof and dustproof structure can be achieved.

### BRIEF DESCRIPTION OF THE DRAWINGS

FIG. 1 is a plan view showing the configuration of a liquid crystal display device according to an embodiment of the present invention;

FIG. 2 is a side view of the liquid crystal display device shown in FIG. 1;

FIG. 3 is a cross-sectional view of the liquid crystal display device, taken along line III-III in FIG. 1;

FIG. 4 is a partial sectional view showing a light guide state in a front light shown in FIG. 2; and

FIG. 5 is a schematic view showing the configuration of a known liquid crystal display device.

### DESCRIPTION OF THE PREFERRED EMBODIMENTS

An embodiment of the present invention will be described in detail below with reference to the attached drawings.

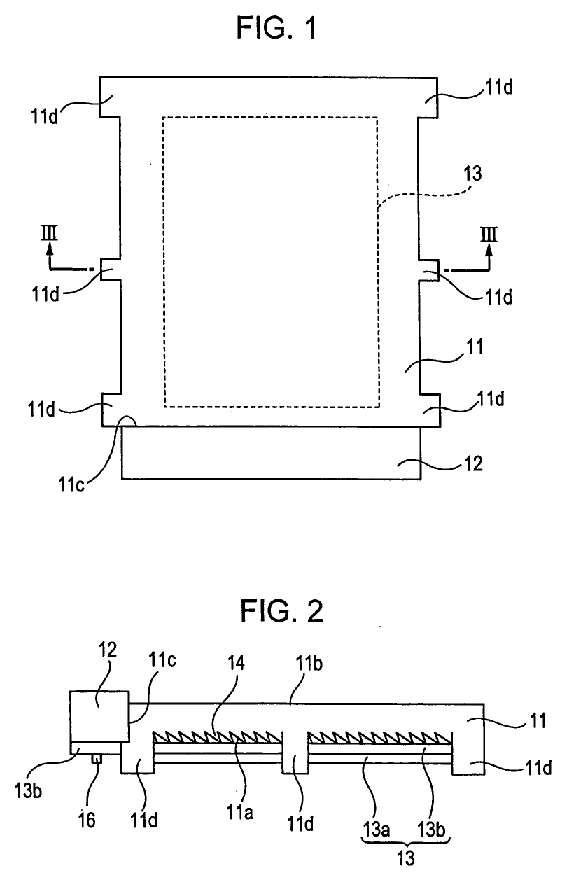

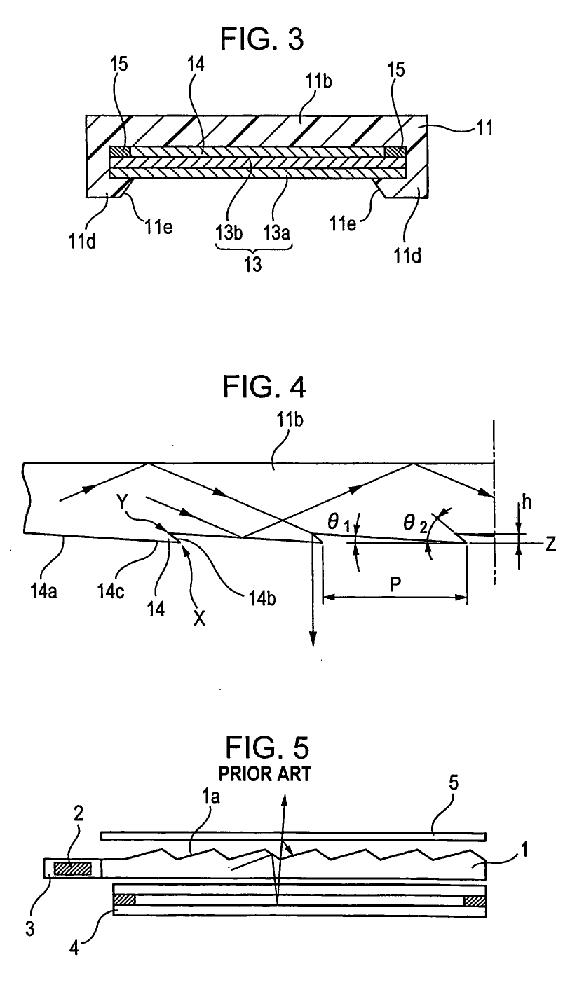

FIG. 1 is a plan view showing the configuration of a liquid crystal display device according to an embodiment of the present invention, FIG. 2 is a side view of the liquid crystal display device shown in FIG. 1, and FIG. 3 is a cross-sectional view of the liquid crystal display device, taken along line III-III in FIG. 1. The liquid crystal display device shown in FIGS. 1 to 3 mainly includes a front light serving as a surface-emitting device and including a light guide plate 11 and a light source 12, and a liquid crystal display panel 13 mounted on one principal surface (lower surface in FIG. 1) of the front light.

As shown in FIG. 2, the front light includes a substantially flat transparent light guide plate 11 having a pair of opposing principal surfaces 11a and 11b, and a light source 12 provided along an end face 11c of the light guide plate 11. For example, the light source 12 includes a long light guide bar disposed along the end face 11c, and an LED disposed near an end face of the light guide bar and serving as a light-emitting element. That is, the end face 11c of the light guide plate 11 forms a light incident surface of the light guide plate 11 in the front light.

The light guide plate 11 of the front light is disposed on the liquid crystal display panel 13, as shown in FIGS. 2 and 3. Light from the light source 12 is emitted from a light-emitting surface of the light guide plate 11 toward the liquid crystal display panel 13. The light guide plate 11 is made of a transparent resin material such as acrylic resin, norbornene resin, cyclic polyolefin resin, or polycarbonate resin, and is formed by, for example, injection molding.

As shown in FIG. 2, the principal surface 11a of the light guide plate 11 facing the liquid crystal display panel 13 (a lower principal surface in FIG. 2, a light-emitting surface) has a plurality of prisms 14.

FIG. 4 is a partial sectional view showing a light guide state in the front light shown in FIG. 2. As shown in FIG. 4, each of the prisms 14 includes a first face (gently inclined face) 14a that is inclined, a second face (steeply inclined face) 14b that is inclined more steeply than the first face 14a and is farther from the end face 11c than the first face 14a, and a third face (flat face) 14c provided between the first and second faces 14a and 14b. An angle (inclination angle) θ₂ formed between the second and third faces 14b and 14c is acute. Therefore, the principal surface 11a is substantially serrate in cross section because of the prisms 14, as shown in FIG. 2. The gently inclined face 14a is inclined at an angle θ₁ with respect to the horizontal reference plane z.

In this embodiment, it is preferable to set the angle θ₂ so that light incident on the end face 11c is reflected by the steeply inclined face 14b and is then emitted out from the flat face 14c. The pitch P of the prisms 14 (the distance between apexes X or Y of the prisms 14) is fixed on the light-emitting surface 11a of the light guide plate 11, and the height of the prisms 14 (the distance between the horizontal reference plane z and the apexes Y of the prisms 14) on the light-emitting surface 11a increases away from the light source 12. The pitch P of the prisms 14 does not always need to be fixed on the light-emitting surface 11a, and may be appropriately changed. The height h of the prisms 14 does not always need to be changed on the light-emitting surface 11a, and may be fixed. Further, the inclination angles θ₁ and θ₂ of the prisms 14 may be appropriately changed. Other structures of the prisms 14 shown in FIG. 4 are described in Japanese Patent Application No. 2004-150286 that the present applicant has filed.

More specifically, it is preferable that the inclination angle θ₁ of the gently inclined face 14a be within the range of 0.5° to 5° with respect to the horizontal reference plane z, and that the inclination angle θ₂ of the steeply inclined face 14b be within the range of 40° to 60°. By setting the inclination angles θ₁ and θ₂ within these ranges, light propagating in the light guide plate 11 can be effectively emitted to the liquid crystal display panel 13, and the liquid crystal display device can produce a bright display. When the inclination angle θ₁ of the gently inclined face 14a is less than 0.5°, the average luminance of the front light decreases. When the inclination angle θ₁ is more than 5°, a uniform amount of emitted light cannot be ensured in the surface of the light guide plate 11. When the inclination angle θ₂ of the steeply inclined face 14b is less than 40° or more than 60°, the amount of light that leaks through the steeply inclined face 14b increases, and the amount of light emitted from the light-emitting surface 11a decreases.

The light guide plate 11 has retaining portions 11d that serve as holding portions and that extend in the normal direction of the principal surface 11a facing the liquid crystal display panel 13. That is, as shown in FIG. 1, a plurality of retaining portion 11d are provided on side faces of the light guide plate 11, and protrude from the principal surface 11a in the normal direction of the principal surface 11a (downward in FIG. 2). The retaining portions 11d respectively have retaining claws 11e at their leading ends, and hold the liquid crystal display panel 13 therein. That is, when the liquid crystal display panel 13 is pushed in a region surrounded by the retaining portions 11d, the retaining portions 11d are bent outward. When the liquid crystal display panel 13 is completely placed in the region, a lower surface thereof is retained by the retaining claws 11e. By thus forming the holding portions (retaining portions lid) in the light guide plate 11, the liquid crystal display panel 13 can be easily aligned and combined with the light guide plate 11 without performing any special operation. Further since the holding portions of the light guide plate 11 can absorb the load and impact, the liquid crystal display panel 13 is protected.

While six retaining portions 11d are provided in this embodiment, the number of the retaining portions 11d is not particularly limited. Further, while the retaining portions 11d are used as the holding portions in this embodiment, other structures can be adopted as long as the light guide plate 11 can hold the liquid crystal display panel 13 therein. That is, the number, positions, and shape of the holding portions are appropriately determined in consideration of the size of the liquid crystal display panel 13 so that the holding portions can reliably hold the liquid crystal display panel 13.

The holding portions are integrally formed with the light guide plate 11. For example, the holding portions can be easily formed in the light guide plate 11 by ejection molding. Even when the holding portions are integrally formed with the light guide plate 11, an optical problem does not arise. That is, an optical problem can be avoided by designing the front light to control each light beam so that the light beam does not leak from the holding portions.

The liquid crystal display panel 13 includes an upper substrate 13b and a lower substrate 13a that oppose each other. A liquid crystal layer (not shown) is sandwiched between the upper substrate 13b and the lower substrate 13a. The liquid crystal layer is sealed by a sealing member (not shown) provided along inner peripheral portions of the upper and lower substrates 13b and 13a. The liquid crystal display panel 13 also includes electrodes for controlling the driving of the liquid crystal layer, an alignment film, semiconductor devices for switching among the electrodes, a reflective layer, and as necessary, a color filter for color display.

The upper substrate 13b of the liquid crystal display panel 13 protrudes from the light guide plate 11 (protrudes leftward in FIG. 2). The light source 12 is provided on one principal surface of the upper substrate 13b (an upper surface in FIG. 2), and a driver IC 16 is mounted on the other principal surface thereof (a lower surface in FIG. 2). The driver IC 16 is electrically connected to the electrodes of the liquid crystal display panel 13 in order to drive the liquid crystal. The light source 12 is provided along the end face 11c of the light guide plate 11. Spacers 15 are provided between the upper substrate 13b of the liquid crystal display panel 13 and the principal surface 11a of the light guide plate 11 having the prisms 14. The spacers 15 prevent rattling between the upper substrate 13b and the principal surface 11a.

When the light guide plate 11 and the liquid crystal display panel 13 having the above-described structures are combined into a module, the liquid crystal display panel 13 is pushed in the region of the light guide plate 11 surrounded by the retaining portions 11d in such a manner as that the upper substrate 13b faces the prisms 14. In this case, the liquid crystal display panel 13 touches and pushes the retaining claws 11e out, and therefore, the retaining portions 11d are bent outward. When the liquid crystal display panel 13 is further pushed from the retaining claws 11e toward the prisms 14, the retaining portions 11d return to their original positions because of elasticity. Consequently, the retaining claws lie retain the liquid crystal display panel 13. The spacers 15 are disposed between the upper substrate 13b and the light guide plate 11. In this way, the liquid crystal display panel 13 is held in and combined with the light guide plate 11.

In the liquid crystal display device having the above-described configuration, a viewer can see the display on the liquid crystal display panel 13 through the light guide plate 11. In a dark environment where external light cannot be obtained, the light source 12 of the front light is lighted. Light emitted from the light source 12 is introduced in the light guide plate 11 through the end face 11c, propagates inside the light guide plate 11, and is emitted from the light-emitting surface (lower surface) 11a of the light guide plate 11 toward the liquid crystal display panel 13. By thus illuminating the liquid crystal display panel 13, the viewer can see the display on the liquid crystal display panel 13 through the light guide plate 11 even in a dark environment.

Since the light guide plate 11 and the liquid crystal display panel 13 are combined, the rigidity and strength of the liquid crystal display device increase as a whole. That is, even when a load is applied from the side of the flat face 11b of the light guide plate 11, it can be absorbed by the retaining portions 11d serving as the holding portions in the light guide plate 11. As a result, the load applied to the liquid crystal display panel 13 is reduced, and the substrates of the liquid crystal display panel 13 are prevented from cracking. Since the liquid crystal display panel 13 is guided and held by the holding portions (retaining portions 11d) of the light guide plate 11, it is aligned and combined with the light guide plate 11 without performing any special operation. Moreover, since the liquid crystal display panel 13 and the light guide plate 11 are combined, foreign substances are prevented from entering therebetween, and a waterproof and dustproof structure can be achieved.

The light-emitting surface 11a having the prisms 14 faces the liquid crystal display panel 13, and the opposite principal surface 11b is flat. Therefore, the cover for protecting the prisms 14 of the light guide plate 11 shown in FIG. 5 is unnecessary, and an optical element can be easily mounted on the principal surface 11b of the light guide plate 11, as necessary.

It should be noted that the present invention is not limited to the above-described embodiment, and various modifications are possible. For example, the shape of the optical element, such as the light guide plate, is not limited to a plate, and may be like a film or a sheet. While the light source includes the LED serving as a light-emitting element and the light guide bar in the above embodiment, it may include other components. Further, while the liquid crystal display panel in the above embodiment is of a reflective type, the present invention is also applicable to a semitransmissive liquid crystal display device. Other modifications may be possible without departing of the scope of the invention.

What is claimed is:

1. A light guide plate comprising:
first and second principal surfaces that oppose each other;
an end face through which light from a light source enters the light guide plate; and
a holding portion extending in a normal direction of the first principal surface,
wherein the first principal surface has a plurality of prisms, and the second principal surface is flat.

2. The light guide plate according to claim 1, wherein the holding portion has a retaining claw at a leading end.

3. The light guide plate according to claim 1, wherein each of the prisms includes a first face that is inclined, a second face that is inclined more steeply than the first face and is farther from the end face than the first face, and a third face provided between the first face and the second face, and
wherein an angle formed between the second face and the third face is acute.

4. The light guide plate according to claim 3, wherein an inclination angle of the first face is within the range of 0.5° to 5°.

5. The light guide plate according to claim 3, wherein an inclination angle of the second face is within the range of 40° to 60°.

6. A liquid crystal display device comprising:
a light guide plate including first and second principal surfaces that oppose each other, an end face through which light from a light source enters the light guide plate, and a holding portion extending in a normal direction of the first principal surface, the first principal surface having a plurality of prisms, and the second principal surface being flat;
a light source provided near the end face of the light guide plate; and
a liquid crystal display panel facing the first principal surface of the light guide plate and held by the holding portion.

7. The liquid crystal display device according to claim 6, wherein the holding portion holds the liquid crystal display panel therein.

8. The liquid crystal display device according to claim 6, wherein the holding portion has a retaining claw at a leading end thereof, and the retaining claw retains a surface of the liquid crystal display panel that does not face the light guide plate.
